(19) United States
(12) Patent Application Publication
(10) Pub. No.: US 2019/0067794 A1
(43) Pub. Date: Feb. 28, 2019

(54) ANTENNA SUITABLE FOR INTEGRATION IN A LAPTOP OR TABLET COMPUTER

(71) Applicant: The Antenna Company International N.V., Netherlands Antilles (CW)

(72) Inventors: Tobias KLEIN, Bochum (DE); Diego CARATELLI, Duizel (NL)

(21) Appl. No.: 15/766,938

(22) PCT Filed: Oct. 10, 2016
(86) PCT No.: PCT/NL2016/050701

§ 371 Date: Apr. 9, 2018

(30) Foreign Application Priority Data
Oct. 9, 2015 (NL) 2015592

(51) Int. Cl. H01Q 1/22; H01Q 5/30; H01Q 1/52; H01Q 1/48

(52) U.S. Cl. CPC H01Q 1/2266; H01Q 1/48; H01Q 1/521; H01Q 5/30

(57) ABSTRACT

Antenna of a shape that allows for its integration in a laptop or tablet computer, which antenna has dual band or multi band functionality, and comprises: an elongate carrier structure of electrically insulating material, and an electric circuitry provided on the carrier structure, which comprises the following electrically conductive elements: a ground plane, two or more antenna elements spaced apart from each other, one or more filter elements which are positioned between a pair of adjacent antenna elements, wherein the antenna elements and the filter elements are electrically connected to the ground plane, and wherein the carrier structure contains a feed connector system that allows for an electrical connection between an external feed line and the antenna elements, and wherein the parts of the carrier structure on which the antenna elements are provided, has a relative dielectric constant of at least 2.0, and is of a substantially solid design, which preferably has a minimum cross-sectional area of 0.30 to 1.5 cm2.

The present invention relates to an antenna of a shape that allows for its integration in a laptop or tablet computer, which antenna has dual band or multi band functionality, and comprises:
a carrier structure of electrically insulating material, and
an electric circuitry provided on the carrier structure, which comprises the following electrically conductive elements:
   a ground plane,
   two antenna elements spaced apart from each other,

and wherein the carrier structure contains a feed connector system that allows for an electrical connection between an external feed line and the antenna elements.

Because of its relatively small size, a laptop or tablet computer offers limited space for integrating an antenna for wireless connection. Hence, the antenna design for a laptop or tablet computer is a challenge to the manufacturer.

An antenna that is commonly applied in laptop computers, is based on two antenna elements spaced apart from each other on a carrier structure. The ground plane and feed connector system allow the antenna to function as such. However, in terms of capacity necessary for multi input/multi output applications (MIMO), it is desirable to improve such an antenna. Furthermore, because of the limited dimensions available for incorporating the antenna in a laptop computer, the antenna is prone to unwanted coupling effects or interference with other electrical devices in the computer itself. It is thus desired that the antenna has a reduced tendency for coupling effects or interference. At the same time, it is a requisite that the antenna radiates an amount of radio-frequency power which is acceptable for exposure to humans.

It is an objective of the invention to provide an improved antenna which partially or completely fulfils one or more of the above requirements.

Accordingly, the invention achieves the above objective, by providing:

An antenna of a shape that allows for its integration in a laptop or tablet computer, which antenna has dual band or multi band functionality, and comprises:
an elongate carrier structure of electrically insulating materials, and
an electric circuitry provided on the carrier structure, which comprises the following electrically conductive elements:
   a ground plane,
   two or more antenna elements spaced apart from each other,
   one or more filter elements which are positioned between a pair of adjacent antenna elements,

wherein the antenna elements and the filter elements are electrically connected to the ground plane,
and wherein the carrier structure contains a feed connector system that allows for an electrical connection between an external feed line and the antenna elements,
and wherein the parts of the carrier structure on which the antenna elements are provided, have a relative dielectric constant of at least 2.0, and are of a substantially solid design, which preferably has a minimum cross-sectional area of 0.30 to 1.5 cm2.

Typically the height and width of the parts of the carrier structure that are provided with the antenna elements are for instance 0.30 cm to 1.0 cm in height and 0.70 to 2.0 cm width.

The parts of the carrier structure on which the respective antenna elements are provided, can be seen as longitudinal sections which have at least a length corresponding with the length of the respective antenna elements in longitudinal direction of the carrier.

Optionally, the parts of the carrier structure that are not provided with the antenna elements may have a hollow design.

The materials forming the carrier structure are basically of a polymer origin, and preferably are polymers doped with metal particles in such a way as to achieve the needed relative dielectric constant value. The preferred materials have suitable properties in terms of flow and adhesion characteristics to allow for injection moulding during manufacturing.

Optionally, organo-metallic compounds can be added to the basic polymer materials forming the carrier structure. The organo-metallic filler can be activated with laser ablation and acts as the catalyst for electroless plating deposition of the antenna radiating flares and filter elements by laser direct structuring (LDS) process.

It has been found by the inventors that a solid carrier structure of a suitable size at the parts that are provided with the antenna elements, contributes a dielectric load to the antenna, which allows to further miniaturize the antenna elements while retaining the basic properties that are required for their function. Furthermore, the carrier structure can act as a dielectric resonator which allows for a re-use of the antenna volume by supporting additional resonant processes especially at higher frequencies, this being useful for extending the operational bandwidth of the basic antenna structure and enhancing the wave radiation process.

In view of enhancing the above beneficial effect of the carrier structure, it is further preferred that the parts of the carrier structure on which the antenna elements are provided, have a relative dielectric constant of at least 2.5, and more preferably of at least 3.0.
Such relatively high values, were not yet used in antennas for laptop or tablet computers.

In addition, the further decrements in size of the antenna elements lead to a better uniformity of the radiation pattern of each antenna element, and a better decorrelation of the signals that are received and transmitted by the group of antenna elements that are included in the whole antenna. These properties are in turn beneficial for achieving enhanced MIMO characteristics in terms of coverage range and throughput at system level.

This further decrement in size of the antenna elements as achieved by the invention, is of crucial importance when considering the space for the whole antenna is limited to be suitable for a laptop or tablet computer. By decreasing the size of the antenna elements, the available distance for separating adjacent antenna elements from each other is automatically enlarged for a given length of the whole antenna. This distance of separation plays an important role in improving the antenna decorrelation.

The dual band or multi band functionality as indicated for the antenna according to the invention, is able to support one or more of the well-known communication protocols, such as WiFi (2.4 GHz/5 GHz bands), WiGig (2.4 GHz/5 GHz/60 GHz bands), CBRS (3.5 GHz band), or cellular (GSM/UMTS/LTE).

The antenna elements included in the antenna according to the invention may have the same or different polarization properties for support of complex MIMO antenna diversity schemes which do not rely on spatial separation only.

Preferably, in the antenna according to the invention each antenna element has a length of 15 mm or smaller in the longitudinal direction of the carrier structure, preferably a length in the range of 9 to 13 mm.

It is advantageous for the invention, when each filter element has a length of 10 mm or smaller in the longitudinal direction of the carrier structure, preferably in the range of 7 to 9 mm.

With further preference, in the antenna according to the invention, each filter element is an electrically passive element which is not adjustable by a connected circuitry.
This simplifies the device which is both advantageous in regard of cost, ease of manufacturing, as well as in terms of reliability and durability.

It is preferred in the antenna according to the invention, that the carrier structure has a first longitudinal side which is substantially free from electrically conductive elements, which side preferably amounts to 20% to 50% of the total longitudinal surface area of the carrier structure.
This simplifies the manufacture of the device which is advantageous in regard of the required manufacturing time and costs.
Further, such a first side being free from conductive elements, makes it especially suitable for mechanically connecting the antenna to the device in which it should be integrated.

It is further preferred in the antenna according to the invention, that the ground plane is mainly provided on a second longitudinal side of the carrier structure, which preferably amounts to 20% to 40% of the total longitudinal surface area of the carrier structure.
This further simplifies the manufacture of the device which is advantageous in regard of the required time and costs.

It is also preferred in the antenna according to the invention that each antenna element and filter element is mainly provided on a third longitudinal side of the carrier structure, which preferably amounts to 30% to 60% of the total longitudinal surface area of the carrier structure.
This further simplifies the manufacture of the device which is advantageous in regard of the required time and costs.

In a preferred embodiment of the antenna according to the invention, the carrier structure has longitudinal sides which comprise a top side, front side, bottom side and back side, wherein
each antenna element and filter element is mainly provided on the top side and front side,
the ground plane is mainly provided on the back side, and
the bottom side is substantially free from electrically conductive elements.

Such an antenna entails an equal orientation of the electrical elements, which was found advantageous for the desired antenna functionality, as well as in regard of an expedient production process of the antenna.

In another preferred embodiment of the antenna according to the invention, the carrier structure has a D-shaped cross-section, of which the flat side is substantially free from electrically conductive elements. This shape fits the hinge cavity of typical laptops in which the antenna is to be integrated. Differently shaped or supershaped cross-sections can be considered for improving fitment in the end device, or the dielectric resonant behaviour of the carrier structure.

Generally, the individual antenna elements used in the invention may be of a design such as a patch antenna.

It was found by the inventors, that the antenna according to the invention is suitable for MIMO applications, while the use of a filter element sufficiently reduces the tendency of coupling between the antenna elements. Furthermore it was found that the antenna radiates an amount of radio-frequency power which is acceptable for exposure to humans.

Preferably in the antenna according to the invention, the carrier structure has the shape of a rod, preferably of a length of 15 to 20 cm.
Typically the height and width of the rod are smaller than 1/10 of the length of the rod, for instance 0.50 cm height and 1.0 cm width. Such dimensions are highly suitable for incorporation in a laptop computer, while being sufficiently large for providing the structure with an electric circuitry that includes an effective antenna structure in terms of the invention.
The volume of the rod may lie in the range of 5.0 to 15.0 cm3.

It is further preferred in the antenna according to the invention, that each antenna element has a dual or multi band functionality, and is preferably operative at 2.4 GHz and 5.0 GHz bands. Such an antenna is in particular suitable for WiFi-applications.

According to a preferred embodiment of the invention, the antenna elements are distributed over the length of the carrier structure in a row wherein each pair of adjacent antenna elements is spaced apart by a similar distance, which preferably is approximately half of the wavelength of the lower frequency of the dual band in which the antenna is operative. Such a spacing distance is advantageous in reducing coupling effects, especially in regard of the lower frequency.
In case the lower frequency is 2.4 GHz, and the antenna comprises three antenna elements, the preferred separation distance is about 6 cm. Small deviation around this value is possible in order to optimize the antenna placement and compensate for the proximity of specific interference by electrical devices within the laptop or tablet computer.
It was found that the reduction of coupling effects was not only achieved for 2.4 GHz, but also for 5.0 GHz.

It is preferred in the antenna according to the invention, that the one or more filter elements are positioned halfway between a pair of adjacent antenna elements. This positioning was found most effective in reducing coupling effects between the antenna elements.

In a preferred embodiment of the invention, each antenna element is individually connected to the ground plane, each filter element is individually connected to the ground plane, and each antenna element is individually connected to the feed connector system.
It was found that such an embodiment contributes in achieving the desired antenna functionality.

With special preference, in the antenna according to the invention, each antenna element comprises:
an antenna flare structure which is mainly positioned opposite to the ground plane,
two antenna arms of which a first antenna arm connects the antenna flare structure with the ground plane, and a second antenna arm connects the antenna flare structure with the feed connector system,
wherein preferably the antenna arms are mainly positioned on a top side of the carrier structure.

Further preferred embodiments of the above antenna element are based on the following respective features:
the antenna arms extend in a direction crossways to the longitudinal direction of the carrier structure.
the antenna flare structure has a main direction parallel to the longitudinal direction of the carrier structure. For instance, the antenna flare structure is in the form of two parallel and spaced apart elongated strips, wherein preferably both strips are connected to each other at their ends.

This type of antenna structure is often referred to as an inverted-F antenna.

With further special preference, in the antenna according to the invention, each filter element comprises:
a filter flare structure which is mainly positioned opposite to the ground plane,
an array of parallel and spaced apart filter strips directly connected to the ground plane,
wherein preferably the filter arm and the array are mainly positioned on a top side of the carrier structure.

The above filter element accomplishes an electromagnetic inductive effect by virtue of the parallel array of filter strips, the filter arm, and the filter flare structure. Such a filter element is known as an electromagnetic bandgap (EBG) filter, and has a structure whose geometry is designed to suppress, deflect, or weaken the electromagnetic waves propagating along the polymer carrier, so that coupling effects between proximal antenna elements is reduced. The precise shape, geometry, size, orientation and arrangement of such a filter determines its properties.

Further preferred embodiments of the above filter element are based on the following respective features:
the filter arm and the array of filter strips extend in a direction crossways to the longitudinal direction of the carrier structure.
the filter flare structure has a main direction parallel to the longitudinal direction of the carrier structure. For instance, the filter flare structure is a single elongated strip, wherein preferably one end of the strip is connected to the filter arm.
the filter element is suitable for reducing coupling effects between proximal antenna elements at a frequency of 2.4 GHz.

With further preference, in the antenna according to the invention, the feed connector system comprises insulated feed lines inside the carrier structure, wherein each feed line is individually connected to a second antenna arm at one end, and at the other end connectable to an external feed line. Such a system further contributes to providing an antenna that is designed as compact as possible, which is advantageous considering the limited space available for incorporation inside a laptop or tablet computer.

Furthermore it is preferred in the antenna according to the invention, that the carrier structure is provided with bores and recesses for mounting the antenna in a laptop or tablet computer. Such a carrier structure is further adapted to take into consideration the limited space available for incorporation of the antenna inside a laptop or tablet computer.

In particular it is preferred that the antenna according to the invention is a molded interconnect device (MID), wherein the electric circuitry is made via laser direct structuring (LDS). These techniques are very suitable for production of the antenna in terms of costs and required precision in providing the electric circuitry. An alternative technique may be based on injection molding the carrier structure, and subsequent printing of deposited silver (PDS).

The carrier structure itself is made via injection moulding using one component, or preferably two components. The use of two components can be desirable when a LDS manufacturing process is adopted. As a matter of fact, a LDS-compatible polymer grade can be used for the over moulding of a thin dielectric shell containing antenna flares and filter elements over a fully solid core made out of a doped polymer material with relative permittivity optimized for antenna miniaturization and MIMO characteristics.

According to a special embodiment of the invention, the antenna flare structure and/or the filter flare structure have a contour

that is conformal with the following superformula:

$${ρ}_{d} ( ϕ ) = {( \vert \frac{1}{a} cos \frac{{m}_{1}}{4} ϕ {\vert}^{{n}_{2}} + \text{/} - \vert \frac{1}{b} sin \frac{{m}_{2}}{4} ϕ {\vert}^{{n}_{3}} )}^{- \frac{1}{{n}_{1}}}$$

wherein:
ρd(φ) is a curve located in the XY-plane,
φ∈[0, 2π) is the angular coordinate,
m1≠0 and m2≠0, and
wherein at least one of n1, n2, and n3 does not equal 2,

and preferably none of n1, n2, and n3 equals 2.

These shapes were found to be effective in obtaining the optimum functionality of the antenna flare structure and/or the filter flare structure for the antenna according to the invention.

According to a further embodiment of the invention, the antenna further comprises a control element for adjusting the amount of gain produced by the antenna elements. In practice, the amount of gain necessary is dependent on the quality of the wireless network. If not detrimental to the quality of the wireless connection, it is advantageous to adapt the gain to a lower level because it results in the user of the laptop or tablet computer being exposed to less radiation, and at the same time reduces the occurrence of coupling effects between proximal antennas.

In a second aspect, the invention relates to a laptop or tablet computer in which an antenna according to one of the preceding claims is integrated, preferably at a location adjacent to the display of the computer. The location of such an integrated antenna near to the display of the computer allows for the most compact design of the computer itself, whilst achieving sufficient effectivity of the antenna itself.

In a third aspect, the invention relates to
an antenna module suitable for assembling an antenna according to the first aspect of the invention, comprising:
an elongate carrier section of electrically insulating material, and
an electric circuitry provided on the carrier structure, which comprises the following electrically conductive elements:
   a ground plane,
   an antenna element,

wherein the antenna element is electrically connected to the ground plane,
and wherein the carrier section contains a feed connector system that allows for an electrical connection between an external feed line and the antenna element,
and wherein the carrier section has a relative dielectric constant of at least 2.0, and is of a substantially solid design, which preferably has a minimum cross-sectional area of 0.30 to 1.5 cm2.

Typically the height and width of the parts of the carrier section provided with the antenna elements are for instance 0.30 cm to 1.0 cm in height and 0.70 to 2.0 cm width.

The carrier section on which the antenna element is provided, can be seen as a longitudinal section which has at least a length corresponding with the length of the antenna element in longitudinal direction of the carrier section.

In the antenna module according to the invention, it is preferred that the antenna element has a length of 15 mm or smaller in the longitudinal direction of the carrier section, preferably a length in the range of 9 to 13 mm.

In the antenna module according to the invention, it is further preferred that the carrier section has a first longitudinal side which is substantially free from electrically conductive elements, which side preferably amounts to 20% to 50% of the total longitudinal surface area of the carrier section.

Also, in the antenna module according to the invention, it is preferred that the carrier structure has a D-shaped cross-section, of which the flat side is substantially free from electrically conductive elements.

With respect to the structures comprised in the antenna module that correspond to similar structures in the antenna of the invention, each individual, preferred feature of the antenna according to the first aspect of the invention, is analogously also applicable to the antenna module according to the third aspect of the invention.

It is remarked that the antenna module is suitable to be applied into a different antenna structure than according to the first aspect of the invention:
As an alternative to the antenna structure according to the first aspect of the invention, the antenna modules may be mounted in line onto a substrate structure, such that they are separated by a void in between. In between those voids, separate filter modules can be mounted, which have a similar built up as the antenna modules. As such, a spanning carrier and ground plane structure which connects all modules is not necessary and can be dispensed with. All modules have their own individual ground plane connected to the ground of the device it is mounted onto, and all modules have their own individual feed connector.

The invention is further explained by the appended figures that illustrate preferred embodiments wherein:

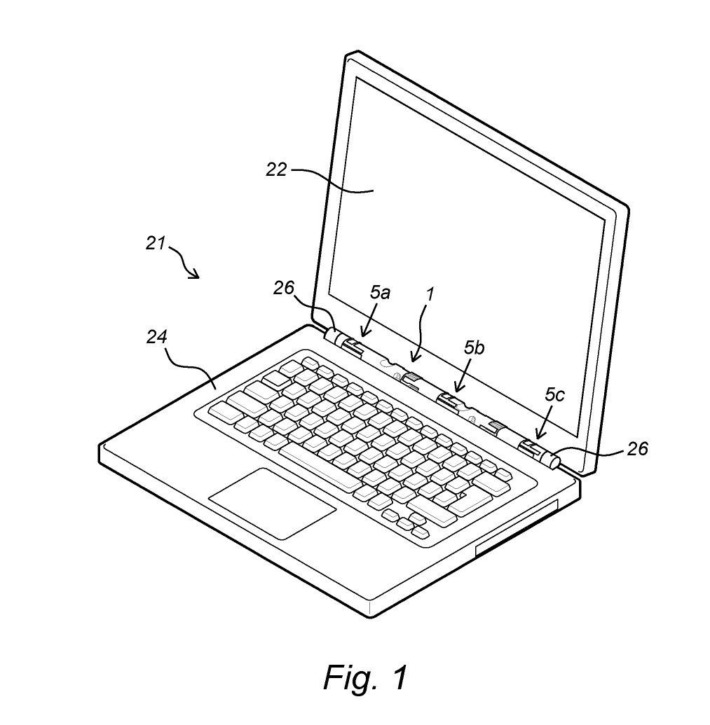

FIG. 1 shows a laptop computer provided with an antenna according to the invention;

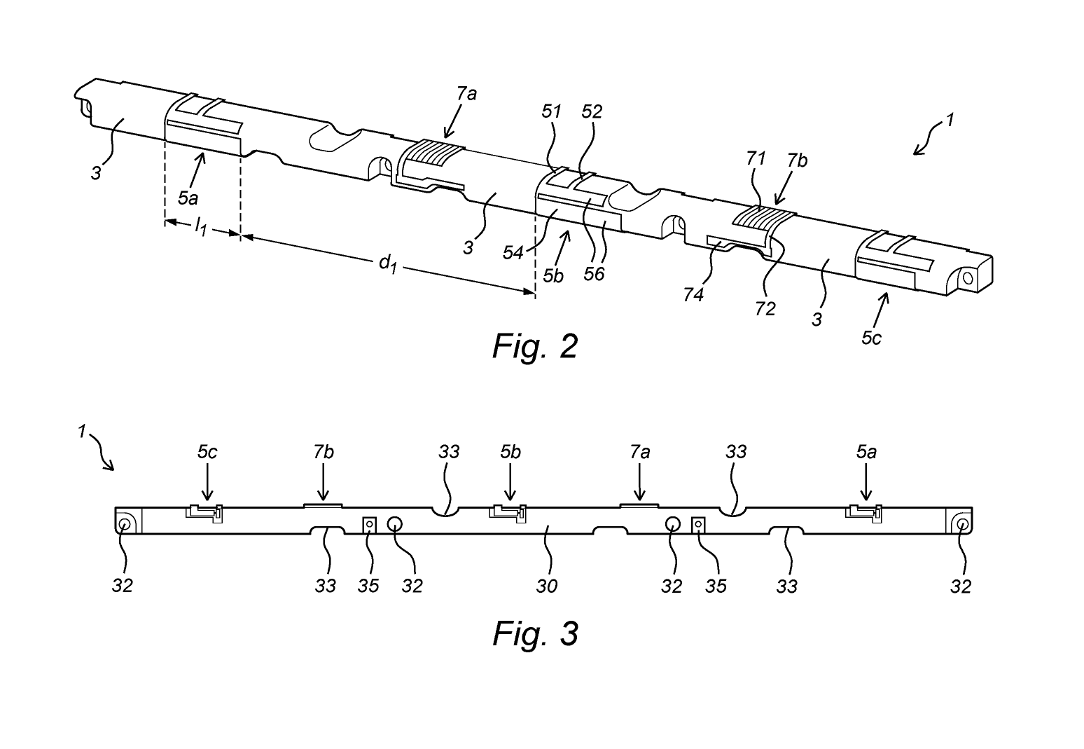

FIG. 2 shows in perspective an antenna according to a preferred embodiment of the invention;

FIG. 3 shows a back side of the antenna;

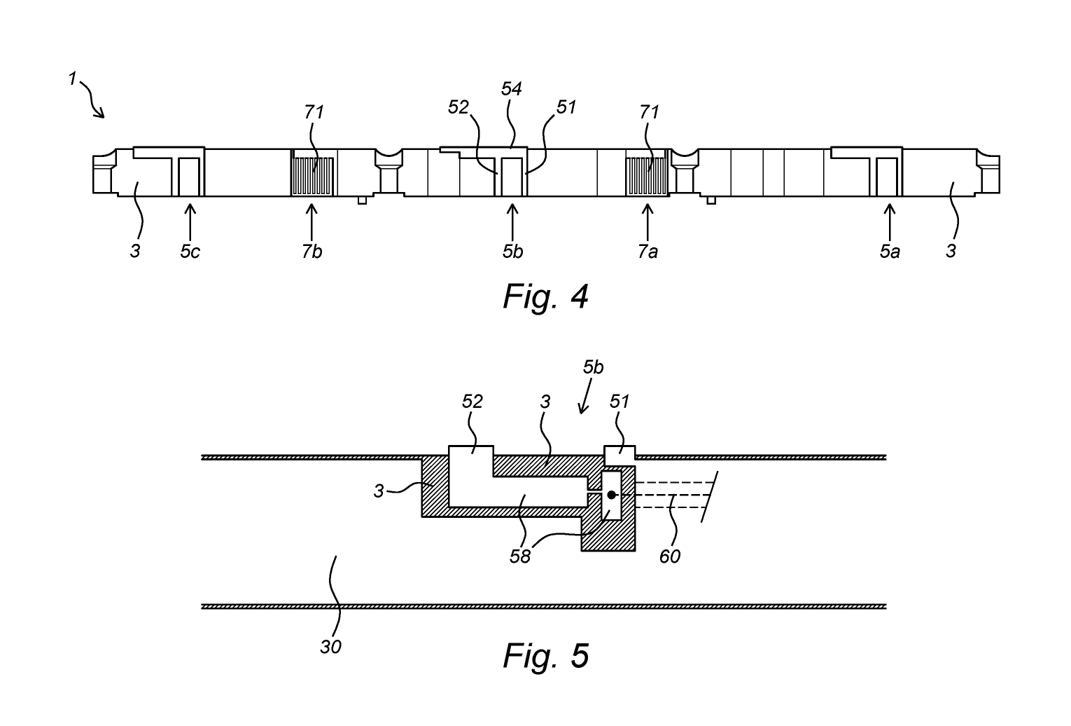

FIG. 4 shows a top side of the antenna;

FIG. 5 shows a detail of the view shown in FIG. 3;

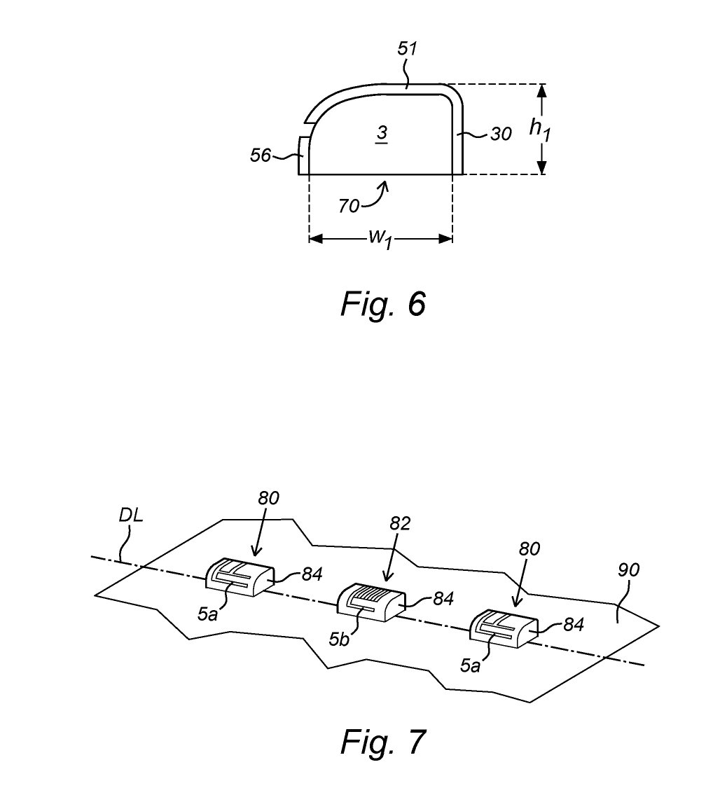

FIG. 6 shows a cross-section of the antenna;

FIG. 7 shows an alternative built-up of an antenna using antenna modules according to the invention.

FIG. 1 shows in an exploded view an antenna 1 provided with three antenna elements 5a, 5b, 5c which is incorporated in a laptop computer 21 between the hinges 26 that connect the screen part 22 to the processor or keyboard part 24. The view is exploded so as to show the position of antenna 1, which is actually hidden underneath the upper surface of the keyboard part 24.

FIG. 2 shows in perspective the front side and top side of the antenna 1, which consists of a carrier structure 3 of insulating polymer material onto which electric elements are provided such as antenna elements 5a, 5b, 5c, and filter elements 7a, 7b. Each antenna element contains a first antenna arm 51, a second antenna arm 52 and an antenna flare structure 54, which consists of two elongated strips 56 parallel to the longitudinal direction of the carrier structure 3 which strips are connected to each other at one end. The length of the first antenna element 5a is indicated as L1. Each filter element contains an array 71 of filter strips crossways to longitudinal direction of the carrier structure 3, a filter arm 72, and a filter flare structure 72 parallel to the longitudinal direction of the carrier structure 3. Although not visible in FIG. 2, the first antenna arm 51 is connected to a ground plane, the second antenna arm 52 is connected to a feed line, and the filter arm 72 is connected to the ground plane.
The separating distance, or space, between two adjacent antenna elements 5a and 5b is indicated as d1.

As an additional feature to what is shown in the figures, the antenna flare structures may be realized in a folded manner in order to reduce the area occupation and achieve an enhanced uniformity of radiation where that is needed or useful for the targeted application.

FIG. 3 shows the back side of the antenna 1 comprising: a ground plane 30 of electrically conductive material, such as copper with nickel and gold coating (when using LDS technology) or silver (when using PDS technology) which extends over virtually the complete back side surface. The carrier structure has been provided with recesses 33 and bores 32 for mounting the antenna inside a laptop computer. Furthermore the carrier structure is provided with connecting points 35 for connecting the feed connector system of the antenna to an external feed line. The feed connector system comprises insulated feed lines inside the carrier structure that are non-visible. Parts of the filter elements 7a,b and the antennas 5a,b,c are visible.

FIG. 4 shows the top side of the antenna 1 with carrier structure 3, comprising the filter elements 7a,b and the antennas 5a,b,c. On the top side are provided the first and second antenna arm 51, 52, and the array of filter strips 71. Part of the antenna flare structure 54 is visible.

FIG. 5 shows in detail antenna element 5b as shown in FIG. 3, comprising a feed connector system, consisting of a body 58 which is insulated from the ground plane 30, by parts of the carrier structure 3. The body 58 is connected to the core of an insulated feed line 60 (shown by dotted lines), which is provided inside the carrier structure underneath the ground plane 30. The other end of the feed line 60 is connected to a connecting point 35 as shown in FIG. 3.

FIG. 6 shows a cross-section perpendicular to the longitudinal direction of the elongate carrier structure 3 at the antenna arm 51, which illustrates that the carrier structure has a D-shaped cross-section, with a given height h1, and width w1. The bottom side 70 is free from electrically conductive elements. The ground plane 30 is provided on the back side, whereas the antenna arm covers the top side and the larger strip 56 of the flare structure is present on the front side.

FIG. 7 shows an alternative to the antenna structure as depicted in the preceding figures, wherein two separate antenna modules 80 having an antenna element 5b are mounted in line (indicated by dotted line DL) onto a substrate structure 90 (only partly depicted), such that they are separated by a void in between. In between this void, a separate filter module 82 having a filter element 5b is mounted. The antenna elements 5a and filter element 5b are provided on a carrier section 84 of similar longitudinal size as the elements themselves. The modules 80,82 each have their own individual ground plane, and their own individual feed connector. The modules 80,82 have a similar D-shaped cross-section as depicted in FIG. 6.

### EXAMPLE

An antenna according to the appended FIGS. 2-5, and having a dual band frequency of 2.4 GHz and 5.0 GHz was produced. The antenna is a molded interconnect device (MID), wherein the electric circuitry is made via laser direct structuring (LDS). The material from which the antenna is produced was a polymer doped with metal particles. The metallization build-up takes place in copper baths. As a final step, a nickel and a thin layer of gold is applied.

As an alternative to the above manufacturing method, the antenna can be produced using printed deposited silver (PDS) technology based on a 3D aerosol jet deposition of silver metallization on the surface of the polymer carrier, as well as FluidANT technology useful for the jet deposition of micron-sized silver flake based ink onto the antenna carrier structure.

The following results were obtained:

At 2.4 GHz:

Average Realized Gain of each individual antenna element: up to −3.6 dB.

Peak Realized Gain: up to 3.1 dBi

Coupling effect observed between each of the three possible pairs of antenna elements is lower than −19.0 dB.

At 5 GHz:

Average Realized Gain of each individual antenna element: up to −4.0 dB

Peak Realized Gain: up to 4.5 dBi

Coupling effect observed between each of the three possible pairs of antenna elements is lower than −20.1 dB.

As an indicator for radiation uniformity, the uniformity of the achieved throughput level has been measured upon rotation of the antenna with respect to the WLAN router.

The throughput level variation over device rotation measured for the antenna, was less than 10%, and typically in the order of 5%. In particular, this was applicable to a situation with high path attenuation (e.g. a large distance to router). The measured results are valid for a broad range of frequency bands, including 2.4 and 5.0 GHz.

As an indicator for decorrelation effects, the envelope correlation coefficient (ECC) is used as a standard. An ECC of 0.01 or smaller, was measured for the antenna over a broad range of frequency bands, including 2.4 and 5.0 GHz.

1. Antenna of a shape that allows for its integration in a laptop or tablet computer, which antenna has dual band or multi band functionality, and comprises:
an elongate carrier structure of electrically insulating material, and
an electric circuitry provided on the carrier structure, which comprises the following electrically conductive elements:
a ground plane,
two or more antenna elements spaced apart from each other,
one or more filter elements which are positioned between a pair of adjacent antenna elements,
wherein the antenna elements and the filter elements are electrically connected to the ground plane,
and wherein the carrier structure contains a feed connector system that allows for an electrical connection between an external feed line and the antenna elements,
and wherein the parts of the carrier structure on which the antenna elements are provided, has a relative dielectric constant of at least 2.0, and is of a substantially solid design.

2. Antenna according to claim 1, wherein each antenna element has a length of 15 mm or smaller in the longitudinal direction of the carrier structure.

3. Antenna according to claim 1, wherein each filter element is an electrically passive element which is not adjustable by a connected circuitry.

4. Antenna according to claim 1, wherein the carrier structure has a first longitudinal side which is substantially free from electrically conductive elements, which side amounts to 20% to 50% of the total longitudinal surface area of the carrier structure.

5. Antenna according to claim 1, wherein
the ground plane is mainly provided on a second longitudinal side of the carrier structure, which amounts to 20% to 40% of the total longitudinal surface area of the carrier structure.

6. Antenna according to claim 1, wherein
each antenna element and filter element is mainly provided on a third longitudinal side of the carrier structure, which amounts to 30% to 60% of the total longitudinal surface area of the carrier structure.

7. Antenna according to claim 1, wherein the carrier structure has longitudinal sides which comprise a top side, front side, bottom side and back side, wherein
each antenna element and filter element is mainly provided on the top side and front side,
the ground plane is mainly provided on the back side, and
the bottom side is substantially free from electrically conductive elements.

8. Antenna according to claim 1, wherein the carrier structure has a D-shaped cross-section, of which the flat side is substantially free from electrically conductive elements.

9. Antenna according to claim 1, wherein the carrier structure has the shape of a rod of a length of 15 to 20 cm.

10. Antenna according to claim 1, wherein each antenna element has a dual band functionality, and is operative at 2.4 GHz and 5.0 GHz bands.

11. Antenna according to claim 1, wherein the antenna elements are distributed over the length of the carrier structure in a row, wherein each pair of adjacent antenna elements is spaced apart by a similar distance which is approximately half of the wavelength of the lower frequency of the dual band in which the antenna is operative.

12. Antenna according to claim 1, wherein the one or more filter elements are positioned halfway between a pair of adjacent antenna elements.

13. Antenna according to claim 1, wherein each antenna element is individually connected to the ground plane, wherein each filter element is individually connected to the ground plane, and wherein each antenna element is individually connected to the feed connector system.

14. Antenna according to claim 1, wherein each antenna element comprises:
an antenna flare structure which is mainly positioned opposite to the ground plane,
two antenna arms of which a first antenna arm connects the antenna flare structure with the ground plane, and a second antenna arm connects the antenna flare structure with the feed connector system,
wherein the antenna arms are mainly positioned on a top side of the carrier structure.

15. Antenna according to claim 1, wherein each filter element comprises:
a filter flare structure which is mainly positioned opposite to the ground plane,
a filter arm which connects the filter flare structure with the ground plane,
an array of parallel and spaced apart filter strips directly connected to the ground plane,
wherein the filter arm and the array are mainly positioned on a top side of the carrier structure.

16. Antenna according to claim 1, wherein the feed connector system comprises insulated feed lines inside the carrier structure, wherein each feed line is connected to the second antenna arm at one end, and at the other end is connectable to an external feed line.

17. Antenna according to claim 1, wherein the carrier structure is provided with bores and recesses for mounting the antenna in a laptop or tablet computer.

18. Antenna according to claim 1, wherein the antenna is a molded interconnect device (MID), wherein the electric circuitry is made via laser direct structuring (LDS).

19. Antenna according to claim 1, wherein the antenna flare structure and/or filter flare structure have a contour that is conformal with the following superformula:
$${ρ}_{d} ( ϕ ) = {( \vert \frac{1}{a} cos \frac{{m}_{1}}{4} ϕ {\vert}^{{n}_{2}} + \text{/} - \vert \frac{1}{b} sin \frac{{m}_{2}}{4} ϕ {\vert}^{{n}_{3}} )}^{- \frac{1}{{n}_{1}}}$$
wherein:
ρd(φ) is a curve located in the XY-plane,
φ∈[0, 2π) is the angular coordinate,
m₁≠0 and m₂≠0, and
wherein at least one of n₁, n₂, and n₃ does not equal 2.

20. Antenna according to claim 1, further comprising a control element for adjusting the amount of gain produced by the antenna elements.

21. Laptop or tablet computer in which an antenna according to claim 1 is integrated at a location adjacent to the display of the computer.

22. An antenna module suitable for assembling an antenna according to claim 1, comprising:
an elongate carrier section of electrically insulating material, and
an electric circuitry provided on the carrier structure, which comprises the following electrically conductive elements:
a ground plane,
an antenna element,
wherein the antenna element is electrically connected to the ground plane,
and wherein the carrier section contains a feed connector system that allows for an electrical connection between an external feed line and the antenna element,
and wherein the carrier section has a relative dielectric constant of at least 2.0, and is of a substantially solid design, which has a minimum cross-sectional area of 0.30 to 1.5 cm².

23. Antenna module according to claim 22, wherein the antenna element has a length of 15 mm or smaller in the longitudinal direction of the carrier section.

24. Antenna according to claim 22, wherein the carrier section has a first longitudinal side which is substantially free from electrically conductive elements, which side amounts to 20% to 50% of the total longitudinal surface area of the carrier section.

25. The antenna according to claim 1, wherein the parts of the carrier structure on which the antenna elements are provided has a cross-sectional area of 0.30 to 1.5 cm².

26. The antenna according to claim 19, wherein none of n₁, n₂, and n₃ equals 2.
